(19) United States
(12) Patent Application Publication
(10) Pub. No.: US 2018/0075547 A1
(43) Pub. Date: Mar. 15, 2018

(54) PROPPANT TRACKING SYSTEM

(71) Applicant: Proppant Express Solutions, LLC, Denver, CO (US)

(72) Inventors: Dominique Dejean Pere, Denver, CO (US); Lambert Gerard Arceneaux, Denver, CO (US); Brian Dorfman, Denver, CO (US); Marc Kevin Fisher, Denver, CO (US)

(21) Appl. No.: 15/703,039

(22) Filed: Sep. 13, 2017

Related U.S. Application Data
(60) Provisional application No. 62/393,972, filed on Sep. 13, 2016.

(51) Int. Cl. G06Q 50/02; G06Q 10/08; G06Q 10/06; G06Q 10/10

(52) U.S. Cl. CPC G06Q 50/02; G06Q 10/0833; G06Q 10/06314; E21B 43/267; G06Q 10/1097; G06Q 10/06312; G06Q 10/06315

(57) ABSTRACT

A tracking system is provided in real time to facilitate proppant delivery in support of oilfield hydraulic fracturing operations. The system prevents operational difficulties that at present are normally encountered in the field by use of automation in scheduling, transporting and tracking containerized proppant, further with status communications occurring among a community of users based in different companies.

### CROSS-REFERENCE TO RELATED APPLICATION

This application claims the benefit of U.S. Provisional Application No. 62/393,972, filed Sep. 13, 2016, which is hereby incorporated herein by reference for all that it discloses.

### BACKGROUND

### Field

The presently disclosed instrumentalities pertain to oilfield and, in particular, control of proppant inventory and fleets of vehicles for moving the proppant over large distances in support of hydraulic fracturing operations.

### Description of the Related Art

Hydraulic fracturing is a well-known technique for stimulating production of oil and gas wells. Recently, this technique has been advanced as an essential aspect of producing oil from shales. Wells that are drilled for this purpose often travel horizontally for large distances, such as distances exceeding one mile. Fracturing of these wells may proceed from zone to zone along the horizontal distance. This type of work is non-traditional in the sense that the jobs pump for extended periods of time and consume significantly more proppant than vertically fractured wells of the past.

These attributes create a need to densify storage and movement of proppant for purposes of hydraulic fracturing that is conducted at a wellsite. By way of example, United States Patent Publication 2014/0305769 to Eiden teaches the use of proppant-filled pods that may be stacked atop a conveyor sled. While Eiden advances the art, the disclosure does not resolve the logistical problems associated with use of these pods. Delivery of proppant is ad hoc, which may cause delays and other operational issues in performing hydraulic fracturing operations. Generally speaking, on-site storage of the proppant pods is frequently limited, and the need to provide just-in-time delivery of additional proppant presents most frac operators with insuperable difficulties. Other problems arise where the functionalities of proppant production, rail transport truck transport, and hydraulic fracturing are usually performed by different vendors, and the overall conduct of the hydraulic fracturing operation may be supervised by a representative of yet another company. The hydraulic fracturing operations have a lot of moving parts, and poor communications across company lines is a leading cause of unnecessary downtime.

### SUMMARY

The presently disclosed instrumentalities advance the art and overcome the problems outlined above by providing a system that automates and controls the delivery of proppant to a wellsite. The system facilitates communications among a community of users that previously have been unable to communicate essential information in this manner. This advantageously permits

According to one embodiment, a computer-assisted dispatch system is improved by the use of a plurality of proppant containers each provided with at least one of a fiducial and a RFID chip for identification of respective containers. A scanner type corresponding to the fiducial or RFID chip is configured to scan for purposes of providing data for computerized tracking of the containers and monitoring the status of the respective containers. The dispatch system is computerized with program instructions for: (1) scheduling delivery of proppant according to the needs of a hydraulic fracturing operation; (2) use of the data in allocating individual proppant transportation jobs to meet the cumulative needs of a schedule for hydraulic fracturing operation; (3) automated placement of the individual transportation orders for transportation according to schedule, wherein the dispatch system is configured to place the transportation orders to at least one proppant supplier for purchase of proppant and at least one transportation vendor for transportation of proppant to a wellsite location; and (4) tracking the delivery of proppant according to schedule to with notifications being provided in case the delivery is not going according to schedule.

In one aspect, scheduling program operates on input from multiple entities including at least a sand controller at a frac company; a transportation company; and a proppant production, storage or trans load company.

In one aspect, the scheduling program provides support for dispatch operations that share data between a plurality of wellsites and a plurality of proppant production, storage, or trans load company facilities.

In one aspect, the scheduling program provides optimization of dispatch operations by use of at least one technique selected from the group consisting of linear programming, nonlinear programming and fuzzy logic.

In one aspect, the program instructions facilitate monitoring a proppant container after delivery to a wellsite location.

In one aspect, the program instructions for scheduling include instructions for automating a dispatch operation for pickup and delivery of a proppant pod by a trucking company.

In one aspect, the dispatch system includes a network accessed by a plurality of smartphones, each presenting an individual trucker with an option to accept an order to deliver proppant for use at a wellsite location.

In one aspect, the program instructions for scheduling include instructions for projecting future proppant needs at a wellsite location in furtherance of a hydraulic fracturing operation.

In one aspect, the program instructions include instructions for automatically adjusting delivery schedule based upon projected needs of the hydraulic fracturing operation as the hydraulic fracturing operation progresses.

### BRIEF DESCRIPTION OF THE DRAWINGS

FIG. 1 shows a community of users including different companies allocated to functionalities required in a hydraulic fracturing operation;

FIG. 2 is a schematic for a handheld device, such as a smartphone or tablet, that may be used to execute program logic according to one embodiment;

FIG. 3 is a process diagram showing program logic that may be utilized for purposes of automation in scheduling, transporting and tracking containerized proppant, further with status communications occurring among a community of users based in different companies;

FIG. 4 provides a network architecture that may be utilized to implement program logic according to the process of FIG. 3;

FIG. 5 is a wheel and hub diagram showing a computer system at the hub of communications between different members of the user community;

FIG. 6 is a process diagram providing additional detail with respect to that of FIG. 3; and

FIG. 7 shows a system organization that is subdivided by software access allocated among user subgroups that are classified as administrative control users, customers, and carriers.

### DETAILED DESCRIPTION

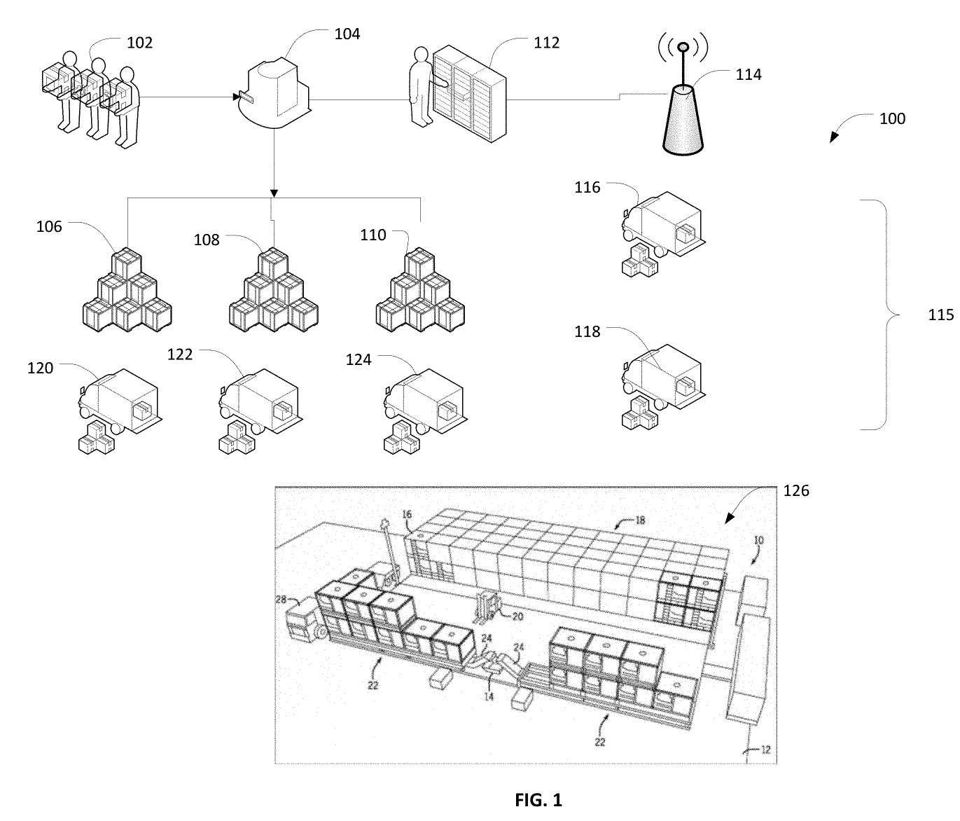

FIG. 1 shows a network 100 for the production, distribution, and use of proppant in support of oilfield operations for hydraulic fracturing. Suppliers 102 provide raw materials for the production of proppant. These raw materials may be, for example, sand that may be further classified by screening or source location. Raw materials may also be those used in making artificial ceramic proppants. A proppant manufacturer 104 receives these raw materials, converting them into different grades of proppants that are typically classified by size.

Inventories of the respectively classified proppants are loaded into containers for storage in areas 106, 108, 110 of similarly classified proppants. More generally, the numeral 104 may also designate any proppant supplier, such as a manufacturer of ceramic proppants, a sand processor that cleans and classifies sand into different grades for use as proppant, or a coater or reseller of products from the manufacturers and sand processors.

The proppant supplier(s) 104 are one member of a user community with authentication-based access to a network computer system 112. One aspect of the system 112 is to provide a wireless dispatch function 114 facilitating control of fleet 115 including any number of trucks, such as trucks 116, 118, 120, 122, 124. As shown in FIG. 1, the trucks 120, 122, 124 are being loaded with containerized proppant from the respective storage areas 106, 108, 110. It will be appreciated that the loading operations may be mixed-and-match in the sense that, for example, truck 120 may be loaded with one or more containers from each of the storage areas 106, 108, 110, or the truck 120 may be exclusively loaded with proppant from just one of these storage areas.

The system 112 dispatches the trucks of fleet 115 onto roadways 126. This dispatch function may be national, regional, or local in scope. The object of this dispatch function is to provide for delivery of containerized proppant to a wellsite location 128, as well as the removal of spent containers that have been emptied in support of hydraulic fracturing operations. Thus, stack 130 provides for storage of individual containers that are filled with proppant.

A forklift 132 moves these containers from stack 130, placing the containers on a conveyor sled 134. Certain containers may reside one atop the other, for example, as container 136 resides atop container 138. These containers discharge their respective loads of proppant onto conveyor 140 for delivery to a central blender 142, which mixes the proppant with liquid to provide a hydraulic fracturing fluid (not shown). The hydraulic fracturing fluid is well known in the art, and is pumped into a well in a manner that stimulates production of naturally occurring hydrocarbon deposits of gas or oil.

Currently, some hydraulic fracturing jobs may consume tens of million pounds of proppant and they may require two weeks or more to pump to completion. Thus, the storage area 130 frequently does not have a sufficient aerial footprint for storage of the required amount of proppant. Moreover, the individual containers of stack 130 are a relatively expensive capital item, as compared to just the proppant. Thus, in some cases it may be impossible to store sufficient quantities of proppant on a single wellsite location 128. Even if the storage area is sufficient, it may be impractical to utilize a sufficient number of containers so as to provide containerized storage for all of proppant that is required for use in a single hydraulic fracturing operation. Therefore, the amount of storage on a single location is increasingly not scaled to provide sufficient proppant for a single hydraulic fracturing operation. The system 112 dispatches incoming trucks 144 to deliver additional proppant as needed, and to pick up empties where the hydraulic fracturing operation has consumed the proppant.

The stack 130 may be divided into discrete storage areas such as areas 146, 148, 150. There may be any number of these storage areas, which are organized into storage of similarly classified containers. For example, area 146 may be classified to store empty containers. Area 148 may be classified to store containers originating from storage area 106. Area 150 may be classified to store containers from storage area 108, and so forth.

Each container in stack 130 and each container on the conveyor sled 134 may be provided with a fiducial, such as a QR code, barcode, or RFID source to aid in tracking of containers that are resident on the wellsite location 128. Similarly, information bearing fiducial, such as a QR code or barcode, may be provided on each container and storage areas 106, 108, 110. The forklift 140 is provided with a scanner (not shown) that communicates with the workover WiFi 152 and the system 112 (see FIG. 1), which tracks the status of each container on the wellsite location 128. The workover WiFi 152 may be, for example, housed in a trailer 154. If more than one forklift is present on the wellsite location 128, each forklift may communicate with the workover WiFi. Signals 156 between the central location tracking system 152 and wireless dispatch function 114 communicate information may communicate the status of individual containers on the wellsite location 128 together with the status of the hydraulic fracturing job, in order to facilitate automated control of dispatch operations by the system 112.

As shown in FIG. 1, the system 112 is located in a single physical location. Alternatively, the central location tracking system may be based upon distributed processing and may utilize distributed databasing to operate out of more than one location.

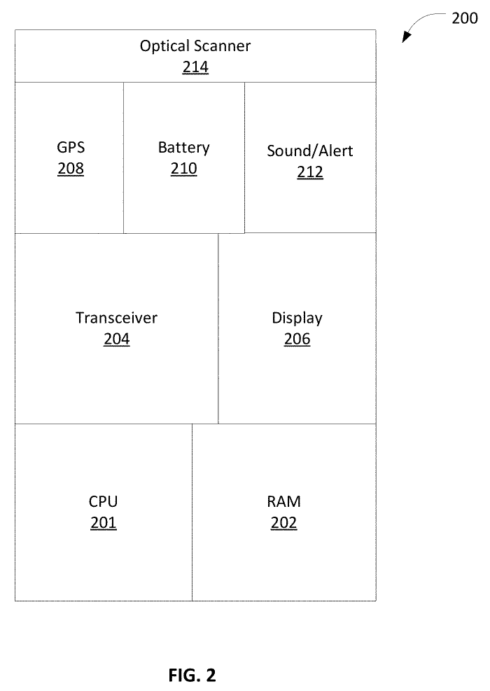

FIG. 2 is a schematic diagram that shows, by way of example, respective components of a handheld device 200 that may be utilized by individuals to communicate with the system, 112. This handheld device may be, for example, a smartphone, a tablet computing device, or an inventory tracking gun, in communication with the workover WiFi 152. A central processing unit 201 is programmatically controlled by the use of software and has access to such internal components as random access memory 202 for purposes of executing program functionality. A transceiver 204 is provided for communication with the wireless dispatch function 114. Display 206 is provided for operator interaction. A global positioning system 208 operates by conventional means to ascertain a physical location of the handheld device 200. The handheld device 200 is powered by battery 210, and is able to provide sounds 212 for purposes of alerting the operator of a system condition. An optical scanner 214 may be a standard camera capable of reading barcodes and the like, or a laser scanner in the case of an inventory tracking gun.

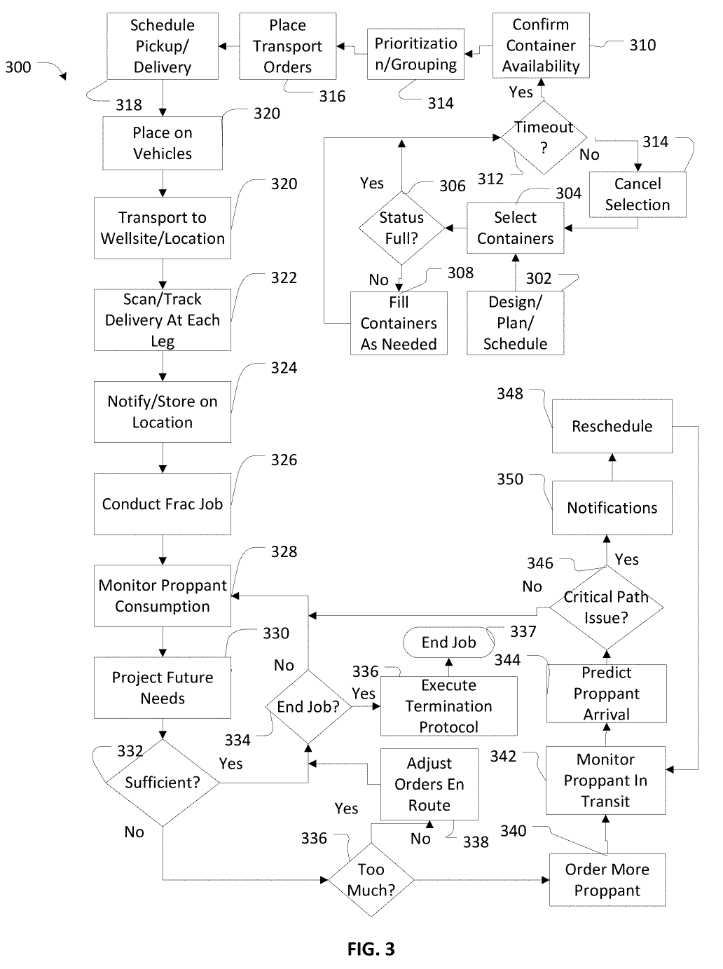

FIG. 3 is a flowchart that shows operation of programmatic control logic or software that may be used in a process 300. The control logic is implemented utilizing program logic to configure the central location tracking system 152 and the system 112 for use in monitoring and tracking of individual containers, as well as the fleet 115, which may be used simultaneously in a variety of hydraulic fracturing jobs such as the one being conducted on wellsite location 128.

Process 300 begins, for example, with design, planning and scheduling 302 of a hydraulic fracturing job. Commercially available software is available for this use, such as FracproPT from Carbo Ceramics or STIMPLAN™ from NSI of Tulsa, Okla. International companies such as Halliburton or Weatherford will design hydraulic fracturing jobs on commercial order, as will local companies such as Liberty Oilfield Services LLC or PropX of Denver, Colo. A schedule for delivery of proppant may, for example, automatically be provided as a data output from a separate software program or this information may be manually entered into the system. The scheduling preferably places event in a prioritized order representing a critical path. For example, a hydraulic fracturing job should not commence until there is a sufficient quantity of proppant on hand to sustain operations uninterruptedly, considering also the ability to deliver additional proppant as the job proceeds.

The system 112 optionally but preferably consults an inventory database of containers in the storage areas 106, 108, 110, and determines whether there is a sufficient inventory of filled containers to meet the demand for proppant according to the schedule. It will be appreciated that the storage areas, such as storage areas 106, 108, 110 may be owned by a single proppant vendor or a plurality of such vendors. Moreover, the storage area may be located at railhead or proppant storage and transloading locations that optionally combine containers and proppant that is sourced from different vendors. Even among the respective vendors, the containers are provided with a unique system identifier associated with an optically scannable fiducial, such as a QR code, or a RFID sensor that may be scanned or accessed at any step of process 300 to inform system 112 of the tracking status of any individual container. The status may be, for example: (1) full, (2) empty, (3) in transport for a particular job, (4) damaged in need of repair, (5) maintenance/inspection, or (6) missing or unknown.

The system 112 optionally but preferably selects 304 individual containers from an inventory of available containers having sufficient capacity to provide proppant for the hydraulic fracturing operation. The selection process preferentially selects individual containers that register with a “Full” status indicating the containers are filled with proppant. If the system 112 determines 306 that the container is not full, then the system requests one or more of the suppliers 104 to fill 308 the containers as needed. System 112 expects to receive receives a handshake confirmation 310 for each individual container from the respective suppliers 104 indicating that the requested containers are filled and ready for pickup. If this has not happened by a certain time or deadline 312 for a particular container, then the selection of that container is cancelled 314 and another suitable container is selected 304. Once 1 306 [symbol] The system 112 places orders 306 from the vendors according to this selection.

Once the container availability is confirmed, the system 112 optionally but preferably prioritizes 314 the containers according to a schedule for conduct of the hydraulic fracturing operation and groups the containers for transportation. By way of example, in the event of rail transport from storage location 106, the system 112 may schedule a plurality of containers for transportation on one or more rail cars. At this time the system 112 also divides the group into subgroups as needed. For example, where it is possible to haul more than one container on a tractor/trailer, the containers may be sub-grouped for this manner of further transportation from a railhead location where the first group is offloaded. Where only a single container may be place on a tractor/trailer for further transport the sub-group become the single container. The system is also provided with a capacity to add groups together. For example, the fleet 115 of tractor/trailers may deliver a plurality of containers to a railhead location. The system 112 may aggregate these containers for subsequent rail shipment.

System 112 next places orders 316 for transportation arrangements. In the simplest case, the optional but preferable step 304 and just places an order for a volume of proppant. A trucker or trans load facility accepts the order and begins filling pods with the proper proppant type. As the containers leave the loading facility they are scanned in to tie the container to the sand type and volume to the trip and ultimately to the wellsite for a particular hydraulic fracturing operation.

The placed orders may take the form of an offer under standard terms for payment of transportation services. The system consults a database of approved transportation vendors, which may include for example trucking companies and railroads. These companies may have their own dispatch operators, which are in communication with the system 112. Alternatively, individual truckers may utilize a handheld device 200, such as a smartphone or tablet interfacing directly with the system 112 through use of a graphical user interface. The system 112 thus facilitating an exchange of information as needed to schedule 318 the pickup and delivery 318 of specifically identified proppant containers. System 112 also identifies load capacities of individual drivers, taking into account such factors as the trucker's tare weight, various overweight permits held by the trucker, road weight restrictions, in order to optimize the sand weight being transported.

Once scheduling 318 is complete, the transportation vendor provides a vehicle, such as a railcar or truck, at the appointed time and place for pickup. The containers are placed 320 on one or more vehicles for ultimate transportation to the wellsite 128, however, any particular vehicle, such as a railcar, may be engaged for only part of this path journey. It will be appreciated that exiting software, such as Google Maps™, is capable of providing instructions that divide a journey into sequential paths or legs, and that different transportation arrangements may be made according to the different legs of the journey. The different legs of the journey may be prepared by a computer system operating off of a set of expert rules, or by a human controller.

An operator scans 322 the QR code or other fiducial on each individual container as the container is being placed 320 on the vehicle. This provides an identifier that is used to inform system 112 for tracking 322 the status of that particular container at each leg of the transportation journey. By way of example, several containers may be placed on a railcar. The containers are scanned at this time, and the information is transmitted to system 112 to indicate that the first leg of the journey is underway. The next leg on the transportation plan requires delivery to a railhead. The containers are scanned when they are offloaded from the railcar and they are each scanned again when they are loaded onto a truck for transport to a wellsite location. The information from this second scan is uploaded to system 112 to confirm that the second leg of the journey is underway. The containers are transported as part of a larger aggregate group, and delivered to a second railhead location where they are scanned upon offloading to inform system 112 of this status. The individual containers are then scanned as they are once again loaded onto trucks.

As part of the tracking 322 when the transportation operator is a trucker, the handheld device optionally but preferably monitors its location at periodic intervals using the internal GPS, and uploads the location information to system 112. This informs system 112 of the location and whether the transportation journey is proceeding on time.

Wellsite locations are very busy places, particularly at times of hydraulic fracturing. A number of operational difficulties are presented by trucks that just drive onto location in an uncontrolled manner. Accordingly, once the truck hauling the containers arrives just outside the wellsite 128, as may be determined by the handheld device 200 or by manual input from the driver, system 112 notifies wellsite operations people that the truck is present and needs to be offloaded for storage of proppant at the wellsite location 128. The storage may occur, for example by placing containers in stack 130 of the wellsite location 128. Scanning of a QR code at this time provides system 112 with notification that the transportation order for those particular containers is complete.

When the inventory of containers that the identified the foregoing scan information identifies to be on location, in storage or in transit is sufficient to support conduct of hydraulic fracturing operation, the operation is conducted 326. As individual containers are placed on the conveyor sled to be drained of proppant, the status of all containers on location is monitored 328. This may be done using, for example, a handset to scan QR codes on the containers as they are loaded and unloaded from the conveyor sled. On-location data from the monitoring process 328 is used in calculations to project future needs 330 by determining, for example: (1) an amount of proppant, typically in weight, that is consumed from the containers, (2) over a particular time, to (3) calculate a current inventory of proppant on location by subtracting the consumed proppant from the initial inventory, (4) a rate of proppant consumption over time calculated as the amount of consumed proppant divided by the time over which the proppant is consumed, and (5) a time to runout determined as the current inventory divided by the rate of proppant consumption.

If the time to runout is sufficient 332 to provide the amount of proppant that is additionally required according to operational design 302, or if the job has unfortunately screened out or halted for some reason, the system 112 determines 334 whether all proppant that can or should be pumped has already been pumped and, consequently, the job should end.

Alternatively, wellsite operations personnel, such as a sand controller, may instruct system 112 that the job is at an end. At job's end, the system 112 executes a termination protocol 336, which is essentially to consult its transportation database and place transportation orders for retrieval and delivery of containers to offsite places, such as a return of the containers to storage areas 106, 108, 110. The process 300 ends 337 upon system 112 receiving confirmation that these transportation arrangements are complete,

If the volume or amount of proppant on hand plus proppant on order is sufficient 334 to meet needs according to design 302 and it is not time to end the job, then the system 112 proceeds to monitor proppant consumption 328.

If the volume or amount of proppant on hand plus proppant on order is insufficient 334 to meet needs according to design 302, then system 112 inquires whether the inventory is too large 336. A determination that the inventory on hand is too large may be made on two bases: (1) the inventory may exceed a total amount that is required to meet cumulative pumping requirement under the parameters of design 302, or (2) the condition (1) is not met, but there is insufficient on-site storage to accommodate additional containers at the present time. If the inventory is too large, then system 12 accesses the data from monitoring 328 to adjust 338 the orders in route. By way of example, if the sand controller notifies the system 112 that the job has screened out, then the system 112 may, in turn, notify the transportation vendors to cancel orders en route. If storage on-site space is unavailable, the system 112 may notify the transportation vendors to delay delivery of additional shipments.

According to one embodiment, the instructions to adjust orders en route 338 proceed to issue in an automated way as diagnosed by the system 112. The system 112 may notify the sand controller that these instructions are being issued, and the instructions will issue contingent upon confirmation by the sand controller. Alternatively, the sand controller may independently notify system 112 of the need to adjust, triggering issuance of the orders. Once the adjustment orders issue, the system again inquires whether the job should end 334, and processing proceeds as discussed above.

If the volume or amount of proppant on hand plus proppant on order is too little 336, then system 112 orders more proppant 340 by placing additional orders for select containers as in process steps 316, 318, 320. The new orders are monitored 342 in the manner described for process step 328. System 112 accesses the data from monitoring 342 to predict 344 when the proppant will arrive. This monitoring may entail, for example, use of a lookup table converting current container status to arrival time based upon past experiences. Alternatively, a required distance may be divided by an assumed rate of travel associated with the current container status.

In some instances, the proppant may not arrive before it is needed. This presents a critical path 346 issue that may adversely affect the hydraulic fracturing operation. There is a need to reschedule 348; however, this requires human intervention, and so the system 112 sends notifications 350 prompting wellsite personnel to reschedule 348 the critical path and, thereafter, system 112 proceeds with monitoring according to the new critical path schedule.

If the timing of proppant arrival does not present a critical path issue 346, then monitoring of proppant consumption proceeds in step 328.

### Bids

The orders that are placed in process steps 316, 336, 340 may be placed in an ad-hoc manner such that system 112 publishes an offer to the transportation vendors who respond in a manner such that the first to respond to a set of predetermined terms gets the job. This will be the usual case where time is of the essence, and system 112 may even categorize orders as “Rush,” for example, to pay relatively more to expedite transportation. “Normal” orders will be the usual case, offering standard rates. The system 112 may also submit offers for “Bid.” In the case of a “Bid” order, system 112 may publish requests for bids to the transportation vendors.

Individual companies or truckers are invited to state what they will charge to meet the schedule for pickup and delivery. The system 112 accepts bids until such time as the bid is closed, and then provides notice to the winning bidder or winning bidders.

### Targeted

System 112 may select individual truckers to receive “Targeted” offers. These offers may be based upon a variety of factors including (1) superior historical cost performance, (2) superior historical time performance, (3) superior historical safety performance, (4) proximity to a place of pickup, (5) permitted weight capacity above other available drivers and (6) any combination of these factors.

### Optimized Transport.

System 112 may select from among a plurality of known transportation charges to apply mathematics that: (1) minimize transportation charges, or (2) minimize transportation time. Where the system 112 is scheduling a multi-legged journey, this may entail a meshing of schedules among a plurality or railroads and/or a plurality of trucking companies. In this case, linear programming or other such optimization techniques may be applied to optimize the economic performance of system 112. These techniques are applied in recognition that transport schedules may vary according to the availability of vehicles for transportation, and that transportation charges may be raised or lowered depending upon the dates setting a window for transportation to occur. Suitable software for use according to computerized techniques where linear programming is desired may be purchased on commercial order, for example, from Lindo Systems Inc. of Chicago, Ill. and CPLEX Optimizer from IBM. Alternative optimization/minimization techniques include fuzzy logic, nonlinear programming, and programmed systems of expert rules. The optimization operates upon variables including at least: (1) distance to travel, (2) fuel cost, (3) operator pay, (4) governmental regulations restricting trucker travel time, (5) container location, (6) vehicle location, (7) availability of rail transport, (8) speed limits, (9) route selection, (10) alternative wellsites, (11) container maintenance requirements, (12) alternative proppant production facilities, (13) time requirements for proppant delivery, (14) vehicle maintenance requirements, (15) permit table load weights, and (16) transportation charges that may vary by time. Any subset of these variables may be used in the optimization solver.

It will be appreciated that the known transportation charges utilized in this approach may be reflected in contractually arranged terms between companies, as well as “Bids” submitted by trucking companies or railroads as described above.

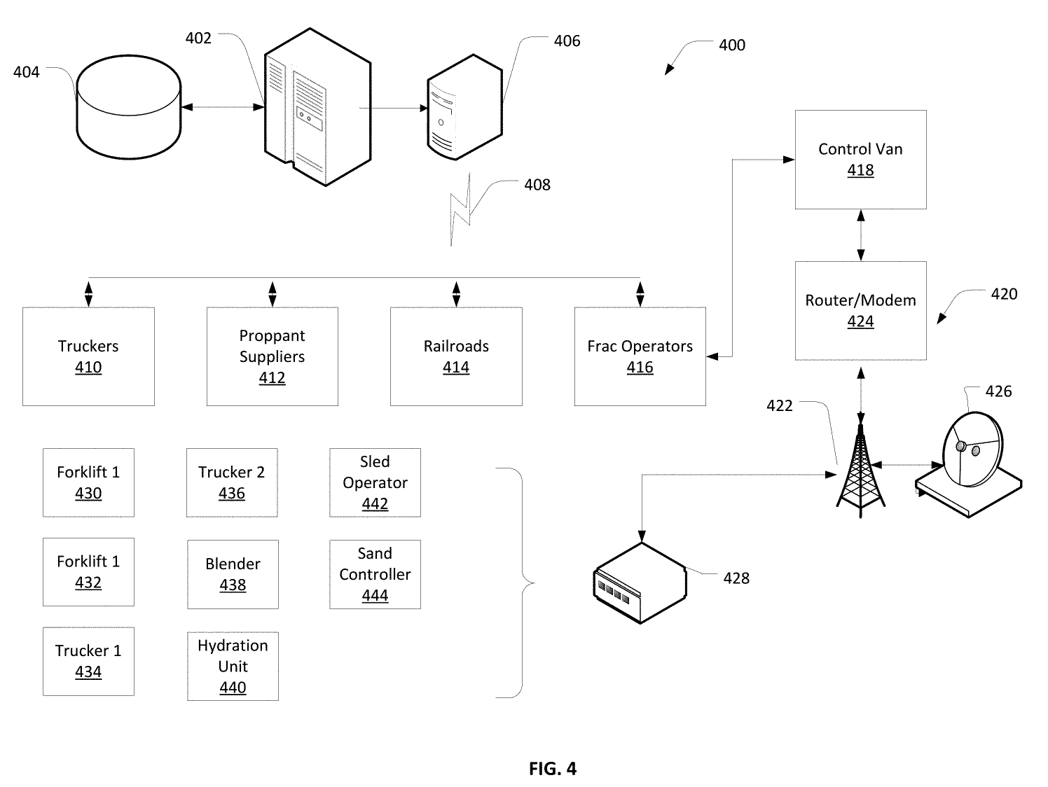

FIG. 4 is a network diagram showing architecture for a system 400 capable of implementing the program logic of FIG. 3 according to one embodiment of implementing the system 112. A computer 402 is configured to access database storage 404, which contains information as needed to execute the system functionalities described in FIG. 3. This includes, for example:
A container database associating a unique container identifier with a container status (full, empty, needs maintenance/repair, full on-site, empty on-site, etc. . . .), empty weight of the container, total weight of the container if full, pod contents, whether the pod has been selected for use in a particular hydraulic fracturing operation, current/last known location of the pod, and who has physical possession of the pod;
A proppant supplier database organizing data for one or more proppant suppliers, location information for operational yards of the suppliers, contact information for the establishment of communications with the suppliers, and a listing of pods under operational control of the proppant supplier, historical cost information, outstanding supplier suppliers offers and terms thereof, current supplier acceptances and terms thereof, historical supplier cost information. and proppant vendor authentication information;
A transportation vendor database organizing data for one or more transportation vendors including vendor type (e.g., trucking company, independent trucker, railroad), mileage rates, schedule of available transport, current/last known location of vehicles, commitments for transportation services by individual transportation orders, transportation scheduling information, transportation job status, vehicle status (travelling, parked, broken down, etc. . . .), projected delivery information, projected pickup information, outstanding transport offers and terms thereof, current transport acceptances and terms thereof and historical cost information; and
An operator database organizing data for one or more companies that provide hydraulic fracturing services including job identifier, job status, wellsite locations, full pods on location, empty pods on location, pods in transport to location, pods allocated to a particular job, hydraulic fracturing job design parameters, and job scheduling data including critical path analysis; and
A geographic information systems (GIS) database used to provide transportation pathways by rail and by truck including a positional listing of road and rail lines, weight restrictions, speed limits, road status (closed, delayed traffic, weather advisory, normal status, under repair, etc. . . .), and leg schedule allocation per job.

The server 402 and mainframe 404 may reside, for example, at an independent location or with any member of the user community. The computer 402 is programmed with logic functioning as described above in context of process 300. The computer 402 is connected to a server 406 utilizing a communications link 408, such as a link to the Internet or the cellular telephone network, to communicate with various user groups who participate in the system 400.

The various user participant groups include, for example, truckers 410 forming fleet 115 (see FIG. 1), Proppant Suppliers 412, Railroads 414, and Frac Operators 416. Although FIG. 4 shows single boxes for groups 410-416, there may be any number of user participant groups according to their respective categories. Truckers 410 may include owner-operators each equipped with a handheld device for interacting with system 112. Alternatively, the truckers may be trucking companies each with their own dispatch operation. The proppant suppliers 412 may be, for example, manufacturers who make ceramic proppants, processors who process sand for use in hydraulic fracturing operations, or middlemen who resell the products of manufacturers and processors. Railroads are, generally speaking, national or local rail lines that have their own dispatch operations. The frac operators are companies who contract with exploration and production companies or drilling companies to perform hydraulic fracturing operations.

Although the Truckers 410 deliver pods to the truckers 410, generally speaking, the Truckers 410, Proppant Suppliers 412 and Railroads 414 form a portion of the user community that primarily operates upstream of the wellsite location 128 and provide the delivery of proppant to the wellsite location. The Frac Operators differ from that part of the user community because the Frac Operators operate primarily at the wellsite location 128 and provide services pumping the proppant into the well.

At the wellsite location 128, a frac operator usually has a control van 418, which may be connected to what is frequently called a workover WiFi, such as workover WiFi 420. This may be, for example, a WiFi hotspot 422 that directs communications to the control van 418 through use of router and modem circuitry 422. The WiFi hotspot 422 has sufficient range to cover the wellsite location 128 using short range radio transmission, such as Bluetooth or a Bluetooth scatternet 428 enabled with repeater stations. Telecommunications off location are facilitated by use of a satellite dish system 426 communicating with link 408. Communications between the satellite dish system 426 and control van 418 pass through the router/modem circuitry and the WiFi hotspot 422.

This arrangement permits all persons working on the wellsite location 128 to communicate with the control van 418 through the workover WiFi 420 or any other suitable radio network known to the art. These persons include one or more forklift operators 430, 432, one or more truckers 434, 436, a blender unit operator 438, a hydration unit operator 440, a conveyor sled operator 442, and a sand controller 444. Each of these individuals may be provided with a handset 200 (FIG. 2) for the conduct of operations according to FIG. 3.

Each element of system 400 is programmed with logic, such as a smartphone application, implementing the respective system functionalities of process 300 as needed for a particular user of that system component. Thus, the program logic of system 112 may be centralized or distributed to provide local functionality, particularly local functionality allocating the process steps 326 to 350 of FIG. 3 to local control by the control van 418 in case the telecommunications link 410 might go down.

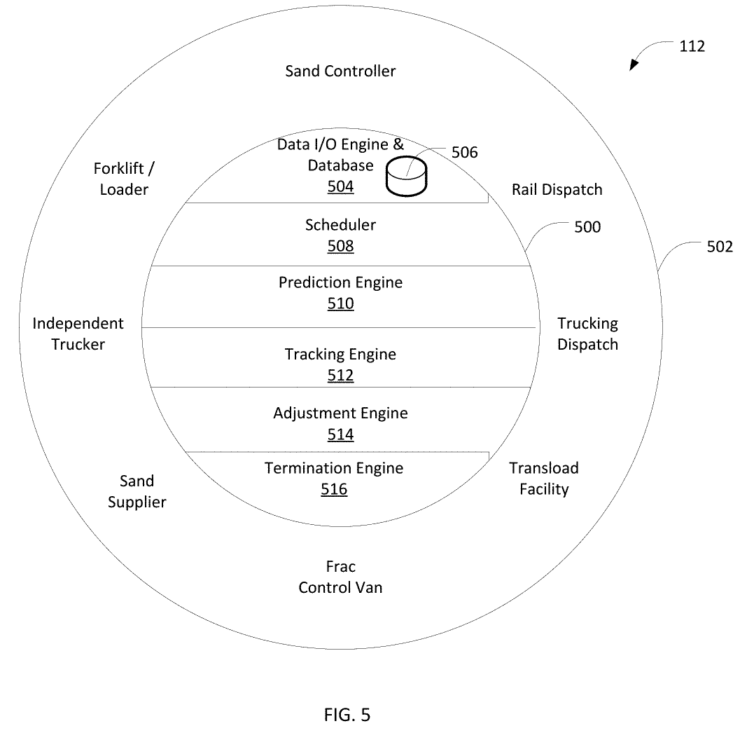

FIG. 5 is a wheel and hub diagram that shows the program functionalities of system 112 at the hub 500 of communications that cross seamlessly through boundaries in a diverse user community including different companies such as a sand controller for a frac company, a forklift loader on a wellsite location, an independent trucker, a centralized trucking dispatch for a trucking company, a sand supplier, a control van for a hydraulic fracturing company, a transload facility, and/or rail dispatch, such that different companies may utilize the single system 112 to perform and monitor all aspects of a hydraulic fracturing operation. Previously, this could not be done because the respective companies lacked a universal system for these communications.

The system 112 is able to resolve logistical problems that would, otherwise, occur among the community of users 502 by executing the features ascribed to these functionalities in FIG. 3. By way of example, the system 112 accesses a data I/O engine 504 manages the data scan information for all containers in the system. Thus, the data I/O engine 504 is accessed for each scan in performing step 302, optional step 304, and steps 319, 322, 328 and 342 as shown in FIG. 3, and stores the collected data in a database 506. Scheduler 508 includes software that identifies tasks that are required in furtherance of a hydraulic fracturing operation, such as the delivery of proppant containers providing a total amount of sand by truckload, and associates each task with a completion date. Preferably but optionally, the scheduler 508 places these tasks in a prioritized relationship indicating which tasks must be completed before other tasks can begin, i.e., to identify a critical path. System 112 accesses the scheduler 508 in furtherance of steps 302, 310, 314, 316, 318, 328, 330, 332, 342, 344, 346 and 348. Scheduler 508 also accesses the database 506 for information storage and retrieval as needed.

A prediction engine 510 utilizes data provided by the data I/O engine and database 504, as well as the scheduler 508, to assess whether proppant will arrive in time for the intended use thereof. By way of example, the prediction engine may utilize global positioning system location information to determine required time as the sum of: (1) miles of travel constituting a required distance to deliver one or more proppant loads to a wellsite, (2) time required for a truck to travel the required distance assuming an average rate of speed; (3) estimated time for transload operations to occur, if needed; and (4) time to generate accepted offers for the transport of proppant. System 112 consults prediction engine 510 to facilitate steps 330 and 344. Prediction engine 510 also accesses the database 506 for information storage and retrieval as needed.

A tracking engine 512 utilizes data from the data I/O engine 504, the scheduler 508, and the prediction engine 510 to ascertain whether proppant will arrive to a wellsite location in time for its intended use. By way of example, the tracking engine may provide suitable notifications to the sand controller or the frac van if proppant will not arrive within a scheduled window, or if there is or will be too much proppant on location. System 112 utilizes the tracking engine in furtherance of steps 328, 330, 336, 338, 340, 342 346, 350, and 348.

An adjustment engine 514 is advantageously utilized to reschedule orders in route according to the current needs of a particular hydraulic fracturing operation. In instances where the tracking engine indicates that proppant will not arrive within a scheduled window, or if there is or will be too much proppant on location, then the adjustment engine 514 determines how much is the scheduled overage or underage of proppant and adjusts the rate of proppant delivery to rectify the overage or underage. This is done by: (1) delaying scheduled shipments of accepted proppant orders, (2) accelerating scheduled shipment of accepted proppant orders, (3) cancelling accepted orders, and/or (4) issuing new orders. Output from the adjustment engine 514 replaces and/or supersedes the scheduling information from step 302. The adjustment engine 514 may be addressed in furtherance of step 342.

An optional but preferable termination engine 516 follows an expert set of rules to wind down site operations upon conclusion of the hydraulic fracturing operation. This includes use of the scheduler 508 to place orders for transport of proppant containers for refill and maintenance as these containers are being removed from the location, as well as reverse tracking as the containers are on the various legs of the return journey.

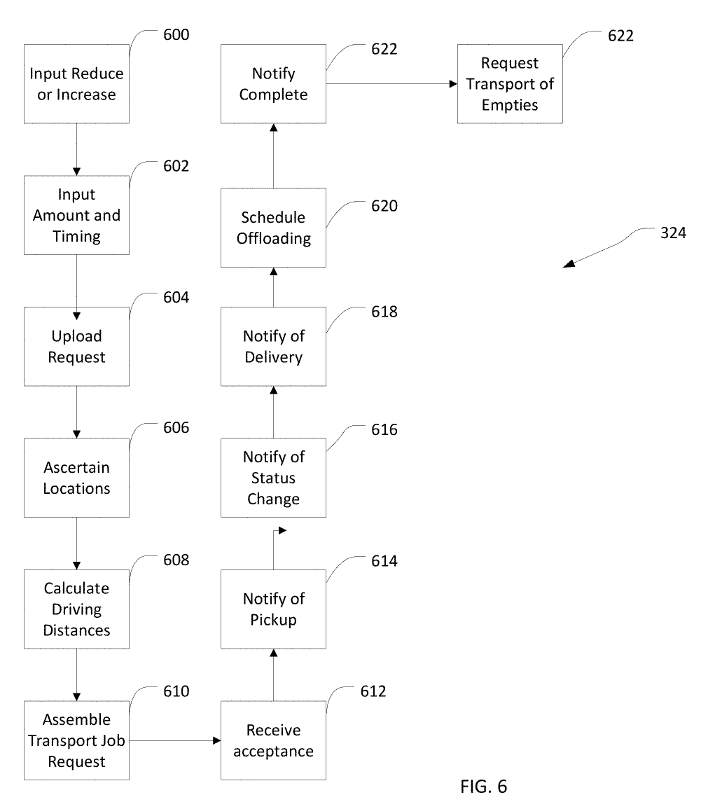

FIG. 6 is a process schematic diagram that shows program logic with additional detail for the conduct of step 338 in FIG. 3. At step 338, the network computer system 112 has provided a sand controller at wellsite 128 with sufficient information indicating that an adjustment is needed to the amount of incoming proppant. A graphical user interface on display 206 (FIG. 2) provides the sand controller with input options 600 to: (1) reduce the volume of incoming sand or (2) increase the volume, together with an input prompt 602 option to identify the amount and type of proppant allocated to either option and to indicate a time by which the action should be complete. The request is uploaded 604 to system 112 through use of workover WiFi 420. Program logic on the system 112 ascertains locations 606 including: (1) a sensed geographic location of the wellsite location 128, and (2) the geographically nearest location of proppant in sufficient quantity to meet the parameters of request 604. Suitable programs are available to determine the driving distances 608, such as Google Maps.

The system 112 next assembles a transport job request 610. This is done by accessing a database to report from a list of transport vendors who are active in the geographic area. This list may include rail transport vendors and trucking vendors. Once a hydraulic fracturing operation is underway, timeliness of proppant delivery is usually more important than cost of delivery. Therefore, the slower rail transport is usually prearranged to provide sufficient quantities of proppant at railhead locations, with there being a preference for ‘last mile’ truck transport from the railhead locations to the wellsite 128. It will be appreciated that the network computer system compiles statistics on transportation operators and may specially select certain vendors to receive the transport job request 610 based upon a history of past performance, such as cost or timeliness performance.

It will be appreciated that process step 338, as expanded in FIG. 6, substantially advances the art as an improvement to existing technology. Previously, the various notification steps were not possible because there has not been a single system capable of providing these notices among the different companies providing their respective services. The sand controller on location was left with the uncertainty of scheduling deliveries and, consequently, in order to assuredly meet demand the locations had to be developed on a much larger aerial footprint to accommodate a larger volume of proppant storage on-site. This also meant that there had to be a larger rearrangement of topsoil when constructing the pad and the removal from the wellsite of other equipment, creating an unnecessary expense. The new system advantageously facilitates a just-in-time inventory system by automating the scheduling and performance of service functionalities.

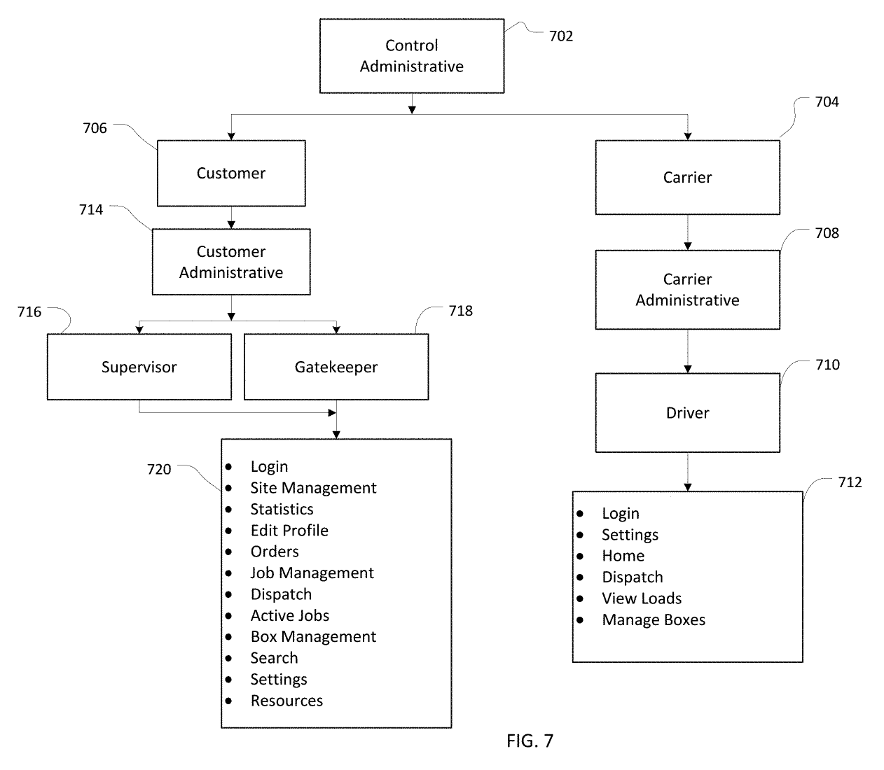

According to one scheme 700 of software access organization, as shown in FIG. 7, a user community may be categorized into three distinct groups, each of which access the system through an interface that is respectively designed for each group. The three basic user groups include control administrative 702, carrier 704, and customer 706. The system permits the user community to view order and inventory information for each job in real time, and to generate load and inventory reports indicating logistical status of transport in progress for fulfillment of job requirements according to the assigned user group.

The administrative users 702 are responsible for assigning roles and permissions to each user type, where a user type is associated with one of the user groups 702, 704, 706. When a particular user is assigned to a group or subgroup, the user is then able to access the aforementioned system through a mobile or web application. The user classification system is preferably organized at the job level, i.e., per hydraulic fracturing operation. The system allows each user to view order and inventory details for each hydraulic fracturing job that has been created in the system. All jobs are displayed to the user through use of a graphical user interface. Primary components of a job are loaders, products, and a destination. Each of these items is defined during the process of setting up a job and saved in a database for future use. Once a job is created, the user community is able to designate and/or identify products, loaders and make appropriate crew and carrier assignments.

The carrier group 704 has its own administrative function 708. Users within the carrier group 706 may be assigned to a driver subgroup. Though use of the carrier group 704, the system notifies drivers and provides the drivers with order information, as well as details through use of a mobile application. The mobile application is a driver interface that allows drivers to review order details before accepting or rejecting a load that is assigned to particular job. Once a load is accepted, the user community is able to monitor the status of each load as the driver completes each stage of the assigned trip and updates the system with container numbers, actual weights, and ticket images. Carrier administrators are users with management or executive level credentials within the carrier business operation. These managers have the highest level of software accessibility and authority within the carrier group. The carrier administrative group 708 may be subdivided into a plurality of users who respectively manage a subgroup of drivers 710. Carrier administrators 708 have access to real-time capability to view assignments of product loads to a driver for delivery, administer and delete load assignments, and update the current status of any drivers within that managers group the graphical user interface may, for example, provide this information in the form of a dispatch dashboard. The carrier administrators may also have access to implement all functions as needed to manage, oversee and supervise all organizational aspects of the driver user fleet. The carrier administrators may also view, access and reconcile all system-generated load and performance reports for associated jobs.

The drivers 710 are each sub-users allocated to a particular assigned carrier administrative manager of the carrier administrative subgroup 708. Thus, there may be many such user-drivers in a group assigned to a single carrier administrative manager, and, in turn, there may also be a plurality of carrier administrative managers. Drivers 710 have access permitting them to: select or edit a truck number; accept, reject and review current load assignments and details; and communicate their load status by scanning a QR code by use of a mobile application in association with a location that is associated with a proppant loading function for pickup or a proppant destination for delivery. The drivers 710 may also upload ticket images for storage into a reporting database. A mobile application provided to the drivers 710 provides a screen flow permitting system functionalities 712 that include login, personal preferences for application settings, a homepage, a dispatch dashboard permitting each of drivers 710 to see their individual contribution as part of an overall job, load information that is relevant to transportation logistics, and box management information.

The customer group 706 includes a customer administrative subgroup 714. The customer administrators 714 have managerial or executive level credentials within a company that performs hydraulic fracturing operations. These managers have complete access to software that facilitates operations for the customer group 706. This system functionality is organized to permit a plurality of individual managers with in the customer administrative subgroup 714 to manage or control a plurality of supervisors 716 and/or gatekeepers 718. Customer administrators 714 may use the system to provide real-time management for adding, deleting and editing trips, for example, by use of a trip builder tab in a dispatch dashboard. The customer administrators 714 may also view all details for a particular hydraulic fracturing job where these details include, for example all loads that have been ordered, haul loads that have been delivered, real-time driver/load status of loads in transit, and a progress bar showing loads that have been delivered for a particular job as tracked through use of a dispatch dashboard. The customer administrators 714 may also access a graphical user interface for the system to view and search for all data pertaining to a particular hydraulic fracturing job. This data may include, for example, products such as proppant by class of proppant, and where this product resides whether at a loading facility or a destination for ultimate use. In summary, the system provides customer administrators 714 with full functionality to overview, manage, oversee and handle all organizational aspects of tasks that are performed in more detail by supervisors 716 and gatekeepers 7168

Supervisors 716 are users who have supervisor level credentials within a field operations division of the customer. Supervisors 716 have access to real-time capabilities for ordering products that will be consumed in a hydraulic fracturing operation, such as proppant, diesel, and chemicals. Supervisors have authority to update the load status of loads that are in progress for delivery. The system may project this information, for example in a dispatch dashboard for all active jobs. The supervisors 716 may also view all inbound products that have been ordered, all products have been delivered, and see the real-time status of driver, load assignments. This information may be projected, for example, in a progress bar indicating delivered product in the dispatch dashboard. The system provides supervisors with real-time capability to dispatch trips and to sign carriers or specific drivers, for example, through use of a dispatch dashboard for a particular job. The supervisors 716 also have real-time capability to review, edit, and manage all customer-associated loads. This functionality may be provided, for example, through a system-provided box management toolbar. The box management toolbar facilitates editing of data including box serial number, box capacity, box unit, status of box, placing the box in or out of service, product type for the box, location the box, and any other additional comments or data is useful for the purpose of box management. The system facilitates download of QR codes associated with each individual box of proppant. Supervisors 716 may view and access system-generated load and performance reports for all jobs associated with a particular supervisor.

Gatekeepers 718 are users with crew boss level credentials within customer operations. Gatekeepers 718 have real-time capability to view/edit/manage all box management data. including box serial number, box capacity, box unit, status of box, placing the box in or out of service, product type for the box, location the box, and any other additional comments or data is useful for the purpose of box management. The box management toolbar facilitates editing of data including box serial number, box capacity, box unit, status of box, placing the box in or out of service, product type for the box, location the box, and any other additional comments or data is useful for the purpose of box management. The system facilitates download of QR codes associated with each individual box of proppant. Gatekeepers 718 may view and access system-generated load and performance reports for all jobs associated with a particular crew.

The system enables supervisors and gatekeepers to verify and validate container information upon delivery by the driver. The supervisors and gatekeepers are also able to monitor inventory in real time through use of a mobile and web based application. The system allows users to access and edit container information at any time by scanning the container QR code or entering the container number. The system provides screen flow to the supervisors and gatekeepers with a menuing system 720 that provides login, site management, statistics, profile editing, orders, job management, dispatch, active jobs, box management, the search functionality, personal settings for use the software, and link outs to other resource.

Those skilled in the art will appreciate that the disclosed instrumentalities may be subjected to insubstantial change without departing from the true spirit of invention. Accordingly, the inventors hereby state their intention to rely upon the Doctrine of Equivalents, if needed, in order to protect their full rights in what is claimed.

1. In a computer-assisted dispatch system, the improvement comprising:
a plurality of proppant containers each provided with at least one of a fiducial and a RFID chip for identification of respective containers;
a scanner corresponding to the fiducial or RFID chip, the scanner being configured to scan for purposes of providing data for computerized tracking of the containers and monitoring the status of the respective containers; and
means for scheduling delivery of proppant according to the needs of a hydraulic fracturing operation, wherein the means for scheduling includes program instructions for
use of the data in allocating individual proppant transportation jobs to meet the cumulative needs of a schedule for hydraulic fracturing operation; and
automated placement of the individual transportation orders for transportation according to schedule, wherein the dispatch system is configured to place the transportation orders to
at least one proppant supplier for purchase of proppant and
at least one transportation vendor for transportation of proppant to a wellsite location; and
means for tracking the delivery of proppant according to schedule with notifications being provided in case the delivery is not going according to schedule.

2. The dispatch system of claim 1 wherein the means for scheduling operates on input from multiple entities including at least a sand controller at a frac company; a transportation company; and a proppant production, storage or trans load company.

3. The dispatch system of claim 1 wherein the means for scheduling provides support for dispatch operations that share data between a plurality of wellsites and a plurality of proppant production, storage, or trans load company facilities.

4. The dispatch system of claim 1 wherein the means for scheduling further includes optimization of dispatch operations by use of at least one technique selected from the group consisting of linear programming, nonlinear programming and fuzzy logic.

5. The dispatch system of claim 4 wherein the technique includes linear programming, nonlinear programming, and combinations thereof.

6. The dispatch system of claim 4 wherein the technique includes fuzzy logic.

7. The dispatch system of claim 4 wherein the technique includes a programmed system of expert rules.

8. The dispatch system of claim 1, further including means for monitoring a proppant container after delivery to a wellsite location.

9. The dispatch system of claim 8 wherein the means for monitoring operates using data representing a status of a proppant pod after delivery to a wellsite location.

10. The dispatch system of claim 1 wherein the means for scheduling includes means for automating a dispatch operation for pickup and delivery of a proppant pod by a trucking company.

11. The dispatch system of claim 1 wherein the means for scheduling includes a network with a plurality of smartphones, each presenting an individual trucker with an option to accept an order to deliver proppant for use at a wellsite location.

12. The dispatch system of claim 1, wherein the means for scheduling further includes program instructions for projecting future proppant needs at a well site location in furtherance of a hydraulic fracturing operation.

13. The dispatch system of claim 12, further comprising means for automatically adjusting delivery schedule based upon projected needs of the hydraulic fracturing operation as the hydraulic fracturing operation progresses.

14. In a computer-assisted dispatch system that provides proppant for use in one or more hydraulic fracturing operations, the improvement comprising:
a plurality of proppant containers each provided with at least one of a fiducial and a RFID chip for identification of respective containers;
a scanner corresponding to the fiducial or RFID chip, the scanner being configured to scan for purposes of providing data for computerized tracking of the containers and monitoring the status of the respective containers; and
a computer network operably configured to implement program instructions for:
scheduling delivery of proppant according to the needs of a hydraulic fracturing operation, wherein the program instructions for scheduling includes instructions for
use of the data in allocating individual proppant transportation jobs to meet the cumulative needs of a schedule for hydraulic fracturing operation;
automated placement of the individual transportation orders for transportation according to schedule, wherein the dispatch system is configured to place the transportation orders to
at least one proppant supplier for purchase of proppant and
at least one transportation vendor for transportation of proppant to a wellsite location; and
tracking the delivery of proppant according to schedule to with notifications being provided in case the delivery is not going according to schedule.

15. The dispatch system of claim 14, further comprising means for automatically adjusting a delivery schedule based upon needs of the hydraulic fracturing operation as the hydraulic fracturing operation progresses.

16. A method of computerized dispatch providing proppant for use in one or more hydraulic fracturing operations by use of the dispatch system of claim 1, the method comprising the steps of;
scheduling a hydraulic fracturing operation to provide a schedule;
through use of the dispatch system;
placing orders for delivery of containerized proppant,
using the data to track orders in transit from a source of supply to a wellsite location;
tracking proppant containers in transit;
tracking proppant use at a wellsite location; and
adjusting a proppant delivery schedule as needed according to the state of a hydraulic fracturing operation.
